(19) United States
(12) Patent Application Publication
(10) Pub. No.: US 2010/0084393 A1
(43) Pub. Date: Apr. 8, 2010

(54) AUTOMATIC HEAT TRACING CONTROL PROCESS

(75) Inventor: Donald C. Nolte, Fremont, CA (US)

Correspondence Address: TYCO INTERNATIONAL, 9 ROSZEL ROAD, PRINCETON, NJ, 08540, US

(73) Assignee: TYCO THERMAL CONTROLS LLC, Menlo Park, CA (US)

(21) Appl. No.: 12/244,499

(22) Filed: Oct. 2, 2008

(51) Int. Cl. H05B 1/02

(52) U.S. Cl. 219/494

(57) ABSTRACT

A method for controlling a heat tracing circuit automatically determines power off time durations. The method calculates the off time duration based on the temperature of a process pipe measured at the end of an initial predetermined power off time interval together with a particular process pipe set point temperature as well as a dead band temperature that is greater than the set point temperature. The set point temperature is based on the process media, heating cable parameters and installation environment of the process pipe. The power off cycle time duration is limited to the time it takes the process pipe temperature to reach the set point temperature, thus limiting the number of on/off cycles of the heat tracing circuit and consequently the life of the circuit components.

### FIELD OF THE INVENTION

Embodiments of the invention relate to the field of heat tracing systems. More particularly, embodiments of the invention relate to an adjustable heat tracing system that automatically regulates power interval timing applied to a heating cable.

### DISCUSSION OF RELATED ART

Electrical heat tracing systems are used to maintain elevated process temperatures in fluid filled pipelines and/or to prevent freezing of various pipeline systems. Heat tracing systems are typically used in various industries including oil and gas, power, food and beverage, chemical and water. A heating cable is attached to a process pipe using glass tape or other fastening mechanism and may be traced around process valves and other heat sinks within the system several times to provide additional heat to these components. A power component is attached to the heating cable to provide the necessary supply of power to form a heat tracing circuit. The power component is also connected via wires to a source of power, such as a power distribution panel and transformer, at a location remote from the process pipe. Various types of heating cables may be employed including self-regulating cables, power limiting cables, constant wattage cables, etc., depending on the particular temperature desired, installation environment and process application requirements. In addition, a monitoring system may also be installed to measure ambient and pipe temperatures, as well as to control the timing and supply of power to the heat tracing cable.

FIG. 1 illustrates a temperature and power timing diagram associated with a prior heat tracing system. In particular, the pipe temperature Tₚᵢₚₑ varies with the passage of time in that the temperature increases (Tₚᵢₚₑ positive slope) as power is applied to the heating cable and the temperature of the pipe decreases when no power is applied to the heating cable. A heating cable can be connected to a transmitter which monitors the power to the heating cable and the temperature of the pipe or the temperature of the process media flowing inside the pipe and transmits this data to a controller. When power is supplied to the heating cable, the transmitters are electrically powered. The transmitters can then communicate pipe temperature information to the controller through wired or wireless connections in an industrial communication network. Examples of typical industrial communications networks are modbus, fieldbus, profibus and the like. Such networks employ a variety of wiring configurations including twisted pair, coaxial cable, and other designs. Similarly, wireless networks employ long-range point-to-point spans and short-hop mesh designs. Power line carrier networks are another typical means of transmitting data. Many communication software standards are employed using these different networks and cable configurations such as RS232, RS-485, or Ethernet. Regardless of the physical network topology or communication protocol, the controller determines if power should be applied to the transmitter and to the heating cable for a period of time in order to increase the pipe temperature.

For example, during the time period tₒₙ, power is applied to the heating cable via a power supply, contactors, such as relay switches, and a controller until the pipe temperature reaches the temperature set point (Tₛₑₜₚₒᵢₙₜ) plus a dead band value (T_{deadband}) at which point the power is turned off at time t₀. The dead band value is the deviation ΔT above the temperature set point that must be reached before power to the heating cable is turned off. During the time period t_{off}, power is not applied to the heating cable or the transmitter via the controller and the pipe temperature decreases (Tₚᵢₚₑ negative slope). Once the pipe temperature reaches temperature Tₒ, power is supplied to the heating cable again via the power supply, relay switches and controller during the time interval defined by time t₁ to time t₂ and remains on during time tₒₙ. This cycle continues as the pipe segment is heated to a temperature above the set point and then cools as the pipe temperature subsequently decreases over time. However, the transmitters are powered only when the power to the heating cable is turned on. Thus, during the time periods t_{off}, the transmitters are without power and cannot send real-time pipe temperature information to the controller, thereby allowing the pipe temperature to drift outside of the desired temperature range.

To overcome the lack of power supplied to the transmitters, prior solutions have configured the controller to briefly apply power to the heating cable at selected time intervals tᵢ. Typical time intervals tᵢ may be, for example every 10 or 15 minutes with a duration of about 15 seconds. This temporarily provides power to the transmitters and allows pipe temperature measurements to be taken which are relayed back to the controller. The controller then determines whether the pipe temperature is far enough below Tₛₑₜₚₒᵢₙₜ to continue to apply power to the heating cable and increase the pipe temperature. However, a drawback associated with this process is that each time the power is turned on only to check the pipe temperature, the number of on/off cycles is increased, thereby causing excessive wear on the switch relays and negatively impacting usage life of the switch. In addition, depending on the frequency and length of the on/off time intervals, a substantial pipe temperature deviation may exist which may compromise the integrity of the process media within the pipes. Moreover, supplying power to the entire heating cable merely to check the pipe temperature unnecessarily wastes power. Thus, there is a need for an automatic heat tracing system that regulates the power to heat tracing cables without jeopardizing the integrity of the process media within the pipe system, does not waste power, and does not reduce the life of the switch. In addition, there is a need for an automatic heat tracing system and process that determines the appropriate time intervals to provide power to the heating cables within the system.

### SUMMARY OF THE INVENTION

Exemplary embodiments of the present invention are directed to a heat tracing system and process. In an exemplary embodiment, the heat tracing process includes measuring the initial temperature of a process pipe which is traced with a heating cable. A set point temperature and a dead band temperature associated with the process pipe is determined for the heat tracing circuit where the dead band temperature is a temperature differential above the set point temperature. Power is applied to the heat tracing circuit for a particular time interval to bring the temperature of the process pipe from the initial pipe temperature to at least the set point temperature plus the dead band temperature. The power to the heat tracing circuit is turned off for a predetermined time duration and the temperature of the process pipe is measured at the end of this time interval. The temperature of the process pipe at the set point temperature plus the dead band temperature is compared to the temperature measured at the end of the predetermined off time interval. A subsequent power off time interval is calculated based on the duration of the predetermined time interval, the dead band temperature, the set point temperature and the initial process pipe temperature such that the temperature of the process pipe at the end of the subsequent power off time interval will not fall below the set point temperature.

### BRIEF DESCRIPTION OF THE DRAWINGS

FIG. 1 is a temperature and power timing diagram of a prior heat tracing process;

FIG. 2 is a block diagram view of a heat tracing systems in accordance with the present invention; and,

FIG. 3 is a temperature and power timing diagram illustrating an automatic heat tracing system in accordance with the present invention.

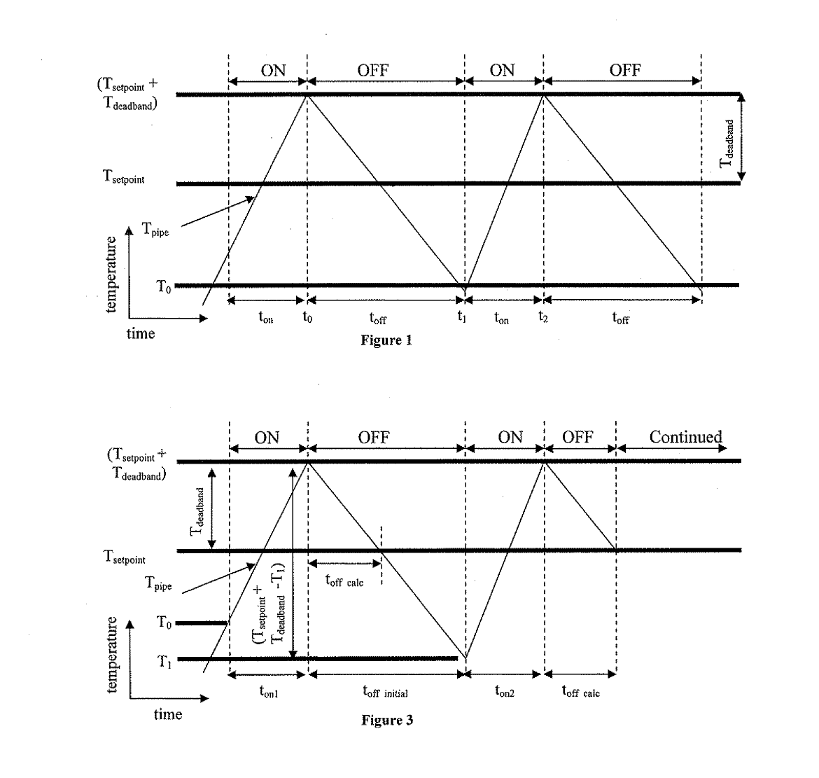

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

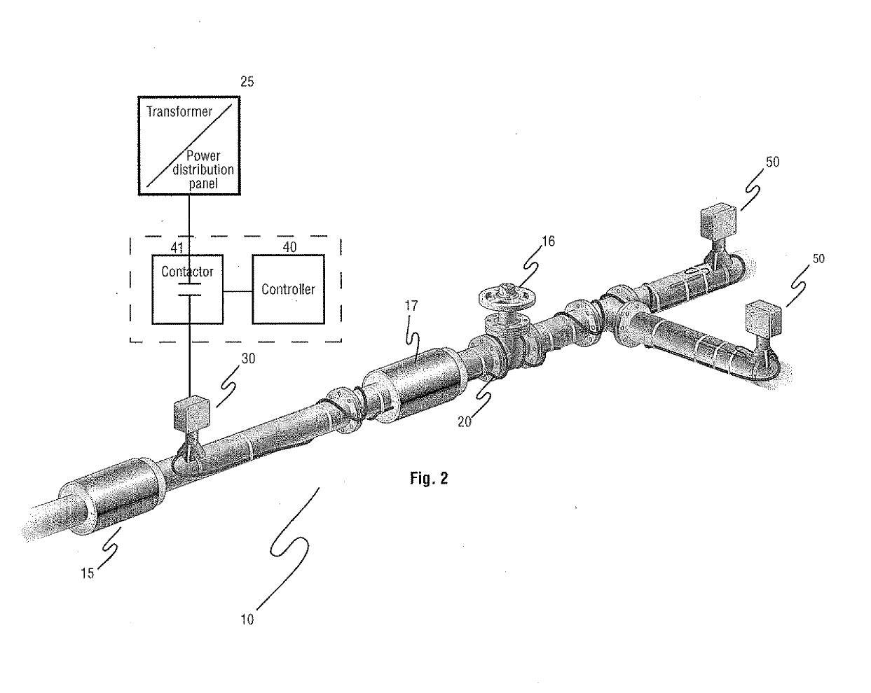

FIG. 2 generally illustrates a simplified heat tracing system 10 in which the automatic control process is implemented in accordance with the present invention. Heat tracing system 10 includes process pipe 15 having a heating cable 20 installed thereon which provides a particular thermal output based on its design and on an input voltage. The process pipe 15 may include a plurality of process valves 16, and/or other heat sinks, and insulated portions 17. Typical heat sinks include, for example, pipe supports, flanges and valves. Typically, heating cable 20 is wrapped on or attached to the process valves to provide additional heat to ensure that the valves function properly. Glass tape or other fasteners are wrapped around, or attached to, process pipe 15 to hold the heating cable 20 in place. The heating cable can be, for example, the self regulating, power limiting, or constant wattage type. In a power limiting type cable, insulation is removed from each of two parallel bus wires at a specific distance along the pipe to form a heating zone having a particular length. In a self regulating type cable, the conductive core microscopically changes in response to temperature fluctuations which either decreases or increases the number of electrical paths between a bus wire pair. In a constant wattage type cable, one or more wires of fixed resistance each form a linear heating element.

Power supply 25 which may include a transformer and a power distribution panel provides necessary power to heating cable 20 via a power connection 30. It should be understood that a single heat tracing circuit is illustrated in FIG. 2 to simplify the explanation, but that a plurality of circuits are typically employed along a process pipe. Controller 40 may include contactor 41 which allows power to flow from power supply 25 to heating cable 20 based on a control signal from the controller. The supply of power to heating cable 20 and the on/off cycles are controlled by controller 40. When controller 40 determines that power may need to be applied to cable 20, transmitter module 50 connected to pipe 15 senses the pipe temperature and transmits this information to controller 40. Additional tee connection components on the heating cable may be employed to provide additional transmitters 50 on the heat tracing circuit. In addition, a remote monitoring module (not shown) may be disposed between controller 40 and transmitter module 50 to provide temperature sensing information from a plurality of heat tracing circuits. Controller 40 can be configured to control an individual heat tracing circuit or a group of heat tracing circuits. Controller 40 typically communicates the received pipe temperature information as well as additional data, to a host computer through a communications link, such as via an RS232, RS485, or Ethernet communication link utilizing, for example, a shielded, twisted pair cable. Based on the pipe temperature detected by transmitter module 50, controller 40 supplies power to the heating cable for a specified time to heat the pipe section 15 to a predetermined temperature based on the operating environment and process media flowing within the pipes. For example, when the temperature of pipe 15 falls below a particular temperature Tₒ, controller 40 allows power to be supplied to heating cable 20 via power supply 25 and contactor switch 41 for a specified time interval tₒₙ. During this time interval, the pipe temperature increases to the temperature set point (Tₛₑₜₚₒᵢₙₜ) plus a dead band value (T_{deadband}). Once pipe 15 reaches the desired temperature (Tₛₑₜₚₒᵢₙₜ₊T_{deadband}) based on information received from transmitter module 50, controller 40 turns off the power to heating cable 20 via contactors 41.

FIG. 3 illustrates a timing and temperature diagram associated with the automatic control process in accordance with the present invention. This process enables the controller 40 to automatically determine the appropriate power off time intervals based on the previous power off time cycle to prevent the pipe temperature from dropping below the set point (Tₛₑₜₚₒᵢₙₜ). In particular, controller 40 provides power to heating cable 20 and to transmitter 50. The pipe temperature increases from an initial temperature (Tₒ) to the set point temperature (Tₛₑₜₚₒᵢₙₜ) plus the dead band differential (T_{deadband}) during time interval tₒₙ₁. Once the pipe reaches the temperature defined by Tₛₑₜₚₒᵢₙₜ+T_{deadband}, controller 40 turns off the power to the heating cable for time interval t_{off}_{_{—}}ᵢₙᵢₜᵢₐₗ which, for this initial first cycle is an arbitrary fixed cycle time. The duration of this arbitrary fixed cycle time depends on the process media, environment, heating cable type, set point temperature, etc.

In a preferred embodiment, during the time interval t_{off}_{_{—}}ᵢₙᵢₜᵢₐₗ the pipe temperature decreases to T₁ at which point controller 40 turns the power to cable 20 on and a pipe temperature measurement is immediately taken by transmitter 50. This temperature reading at the end of the time interval t_{off}_{_{—}}ᵢₙᵢₜᵢₐₗ and before the start of interval tₒₙ₂ indicates the pipe temperature differential between the set point temperature plus the dead band temperature (Tₛₑₜₚₒᵢₙₜ+T_{deadband}) to temperature T₁ during the first power off interval cycle t_{off}_{_{—}}ᵢₙᵢₜᵢₐₗ. Once the initial cycle interval t_{off}_{_{—}}ᵢₙᵢₜᵢₐₗ terminates, controller 40 provides power to heating cable 20 for the cycle interval tₒₙ₂ until the pipe temperature reaches Tₛₑₜₚₒᵢₙₜ+T_{deadband} at which point controller 40 again turns the power off. The automatic adjustment function uses the duration of the arbitrary fixed time interval t_{off}_{_{—}}ᵢₙᵢₜᵢₐₗ, the pipe temperature T₁ taken at the end of the t_{off}_{_{—}}ᵢₙᵢₜᵢₐₗ cycle, the temperature set point (Tₛₑₜₚₒᵢₙₜ) and the temperature deadband (T_{deadband}) and calculates a new value for the duration of the next off cycle (t_{off}_{_{—}}_{calc}). The duration of the off cycle time interval (t_{off}_{_{—}}_{calc}) is limited to the time that the controller calculates it will take the pipe temperature to reach the set point temperature (Tₛₑₜₚₒᵢₙₜ). A calculation that assumes a constant rate of change of pipe temperature is as follows:

t_{off calc}=(t_{off initial}×T_{deadband})/(Tₛₑₜₚₒᵢₙₜ+T_{deadband}−T₁)

Alternatively, a calculation can instead accommodate non-constant rates of change of pipe temperature, for example, exponential decay rates. When appropriate, for small excursions of temperature and slow rates of change, the calculation that assumes a constant rate of change of pipe temperature is a good approximation for exponential rates of decay. The calculation can be also repeated by the controller on a periodic schedule or when the pipe temperature has been determined to have drifted significantly below the desired set point. Also, the initial and subsequent pipe temperatures can be values measured by a single transmitter, or they can be the minimum or average of values measured by several transmitters. In this manner, brief power cycles applied to the heating cable at multiple time intervals during the off cycles by the controller are avoided. This reduces the wear and tear on various system components including the contactor switches and solid state relays. In addition, by calculating the duration of the off cycles, unnecessary power used to turn the heating cable on merely to obtain a temperature reading from the transmitter is avoided, thereby reducing overall system power consumption. Additionally, minimum time periods may be implemented to monitor temperatures, as necessary for process assurance concerns, including process criticality provisions, or other process reasons, such as considerations of pipe size, insulation functionality relative to ambient conditions, and other like considerations determinable by those skilled in the art of heat tracing.

While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A method for controlling the power supplied to a heat tracing circuit disposed around a process pipe comprising:
measuring the initial temperature of the process pipe;
setting a set point temperature for the heat tracing circuit;
setting a dead band temperature above said set point temperature;
applying power to the heat tracing circuit for a particular time interval to bring the temperature of said process pipe at least to the set point temperature plus the dead band temperature;
turning the power to the heat tracing circuit off for a predetermined initial time duration;
measuring the temperature of said process pipe at the end of said predetermined initial time off duration;
comparing the temperature differential of said process pipe between said set point temperature plus the dead band temperature and the temperature measured at the end of said predetermined initial time off duration; and
calculating a subsequent power off time interval based on the duration of the predetermined initial time off duration, the dead band temperature, the set point temperature and the initial process pipe temperature such that the temperature of said process pipe at the end of said subsequent power off time interval does not fall below said set point temperature.

2. The method of claim 1 wherein the power off time interval calculation is based on the formula t_{off}_{_{—}}_{calc}=(t_{off}_{_{—}}ᵢₙᵢₜᵢₐₗ×T_{deadband})/(Tₛₑₜₚₒᵢₙₜ+T_{deadband}−T₁) wherein t_{off}_{_{—}}_{calc} is the subsequent power off time interval, t_{off}_{_{—}}ᵢₙᵢₜᵢₐₗ is the predetermined off time duration, T_{deadband} is the dead band temperature above said set point temperature, Tₛₑₜₚₒᵢₙₜ is the set point temperature for the heat tracing circuit and T₁ is the final temperature of the process pipe.

3. The method of claim 1 further comprising the step of turning power to said heat tracing circuit on after measuring the temperature of said process pipe at the end of said predetermined initial power off time duration.

4. The method of claim 1 further comprising measuring the temperature of said process pipe at the end of the subsequent power off time interval.

5. The method of claim 4 further comprising comparing the temperature differential of said process pipe between said set point temperature plus the dead band temperature and the temperature measured at the end of said subsequent power off time interval.

6. The method of claim 5, further comprising the step of calculating the power off time of one or more subsequent cycles based on the differential.

7. A heat tracing system comprising:
a transmitter associated with a process pipe, said transmitter configured to detect the temperature of said process pipe;
a heating cable attached to said process pipe;
a power supply connected to said heating cable through a contactor switch to provide power to said heating cable;
a controller communicating with said contactor switch and said transmitter, said controller configured to turn the power to said heating cable on and off via said contactor switch based on the temperature of said process pipe wherein said transmitter measures the temperature of said process pipe at the end of an initial time duration when power to said heating cable is turned off, and calculating subsequent power off intervals such that the temperature of said process pipe at the end of a particular one of said subsequent power off time interval does not fall below a predetermined set point temperature.

8. The heat tracing system of claim 6 wherein the transmitter is configured to measure an initial temperature of said process pipe and provide this information to the controller.

9. The heat tracing system of claim 7 wherein said controller is configured to maintain a set point temperature associated with said heat tracing circuit.

10. The heat tracing system of claim 8 wherein said controller is configured to maintain a dead band temperature associated with said heat tracing circuit, said dead band temperature being greater than said set point temperature.

11. The heat tracing system of claim 9 wherein said controller is configured to allow power to be supplied from said power supply to said heat tracing circuit for a particular time interval to bring the temperature of said process pipe at least to the set point temperature plus the dead band temperature.

12. The method of claim 1, further comprising the steps of (a) measuring the temperature of said process pipe at the end of said calculated subsequent power off time interval, (b) comparing the temperature differential of said process pipe between said set point temperature plus the dead band temperature and the temperature measured at the end of said calculated subsequent power off time interval; and (c) calculating an additional subsequent power off time interval based on the duration of the predetermined initial time off duration, the dead band temperature, the set point temperature and the subsequent measured process pipe temperature such that the temperature of said process pipe at the end of said subsequent power off time interval does not fall below said set point temperature.

13. The method of claim 12, wherein the steps of (a)-(c) are repeated n number of times, wherein n is equal to, or greater than 2.

14. The method of claim 13, wherein n is equal to about 10,000 or more.

15. The method of claim 14, wherein n is equal to about 10,000,000 or more.
